(19) United States
(12) Patent Application Publication
(10) Pub. No.: US 2026/0079088 A1
(43) Pub. Date: Mar. 19, 2026

(54) Heating module and flash evaporator

(71) Applicant: SHIMADZU (CHINA) CO., LTD., Shanghai (CN)

(72) Inventors: Donghua NI, Shanghai (CN); Dongwei HU, Shanghai (CN)

(21) Appl. No.: 19/325,833

(22) Filed: Sep. 11, 2025

(30) Foreign Application Priority Data
Sep. 18, 2024 (CN) 202422280564.7

(51) Int. Cl. G01N 1/44

(52) U.S. Cl. CPC G01N 1/44

(57) ABSTRACT

The present disclosure relates to a field of analysis apparatuses, and specifically to a heating module and a flash evaporator. The heating module includes a heating block, a flash evaporation tube, and a metal filling portion. The heating block has a groove, the flash evaporation tube is disposed in the groove, and the metal filling portion is disposed in the groove to fill a gap between the heating block and the flash evaporation tube. The heating module according to the present disclosure can make heat generated by the heating block be quickly and evenly transferred to the flash evaporation tube, so that a fluid inside the flash evaporation tube can be evenly and quickly heated.

### BACKGROUND

A working principle of a heating module of a flash evaporator is based on a flash evaporation phenomenon, that is, instantaneous high temperature and high pressure makes water or other liquids evaporate quickly to form steam. The heating module is widely used in fields of energy and chemical industry, pharmaceutical and food, and environmental protection processes due to rapid heating ability and high pressure technology of the heating module, and can be specifically used in sample pretreatment of gas chromatography analysis.

In the heating module, a liquid in a flash evaporation tube is quickly heated and evaporated to form steam by a heating block, but heat transfer between the heating block and the flash evaporation tube is poor, and thus, the liquid in the flash evaporation tube is difficult to be heated evenly, thereby affecting an analysis result.

### SUMMARY

In view of the above problems, the present disclosure provides a heating module, which allows heat to be quickly and evenly transferred to a flash evaporation tube, so that a fluid inside the flash evaporation tube is evenly and quickly heated.

The present disclosure provides a heating module including a heating block, a flash evaporation tube, and a metal filling portion. The heating block has a groove, the flash evaporation tube is disposed in the groove, and the metal filling portion is disposed in the groove to fill a gap between the heating block and the flash evaporation tube. An all-metal integrated member is formed between the flash evaporation tube and the heating block, so that heat transfer becomes faster and a temperature control becomes more precise.

Optionally, the metal filling portion is formed by filling the groove with a liquid metal and solidifying the liquid metal. The gap between the heater and the flash evaporation tube can be densely filled with the liquid metal, so that the heat transfer is more efficient and faster.

Optionally, the liquid metal is tin, zinc, or aluminum.

Optionally, the groove is an annular groove, the annular groove includes an inner annular wall portion and an outer annular wall portion spaced apart from each other, and the flash evaporation tube is wound and attached to the outer annular wall portion. An inner wall of the flash evaporation tube is usually coated with an inert layer to prevent a liquid in a pipeline from corroding and damaging the pipeline and to prevent the inner wall of the pipeline from adsorbing a sample. By winding and attaching the flash evaporation tube to the outer annular wall portion, a radius of curvature of the wound flash evaporation tube can be increased to protect the inert layer on the inner wall of the flash evaporation tube.

Optionally, the groove extends in a vertical direction, and a notch of the groove is located at the top of the groove. Even if the metal with which the groove is filled is liquefied at high temperature, continuous heat conduction is not affected, so that limitation of a metal melting point can be broken through to achieve a higher flash temperature.

Optionally, a cover plate covers the notch of the groove and is fixedly connected to the heating block. The cover plate can prevent an external insulation material from coming into contact with the metal filling portion, and even if the metal is liquefied, the liquefied metal does not overflow to come into contact with the insulation material.

Optionally, the heating block includes a metal block, a heating rod housing groove disposed at an end of the metal block, and a heating rod embedded into the heating rod housing groove in a fitting manner. According to such a disposing manner, a structure of the heating module becomes more compact and the heat transfer becomes faster.

Optionally, the heating block further includes a temperature sensor disposed at the end of the metal block. By disposing the temperature sensor at this position, a real-time temperature of the flash evaporation tube can be more accurately and sensitively reflected.

Optionally, an outer wall of the heating rod and an outer wall of the temperature sensor are both wrapped with a metal foil. The metal foil can maintain stable heat transfer between components in the presence of certain system tolerances or assembly tolerances.

### BRIEF DESCRIPTION OF THE SEVERAL VIEWS OF THE DRAWINGS

FIG. 1 is a schematic diagram of a structure of a heating module according to an embodiment of the present disclosure.

FIG. 2 is a schematic diagram of a structure of a heating module obtained by removing a cover plate of the heating module according to the embodiment of the present disclosure.

FIG. 3 is a schematic diagram of an assembly structure of a heating block and a flash evaporation tube according to an embodiment of the present disclosure.

Reference numerals: heating module 100, heating block 1, metal block 1a, annular groove 2, outer annular wall portion 2a, inner annular wall portion 2b, flash evaporation tube 3, metal filling portion 4, U-shaped groove 5, heating rod housing groove 5a, temperature sensor housing groove 5b, heating rod 6, temperature sensor 7, aluminum foil 8, cover plate 9, screw 10, screw hole 11.

### DETAILED DESCRIPTION OF THE DISCLOSURE

Technical solutions in embodiments of the present disclosure will be clearly and completely described below with reference to the accompanying drawings in the embodiments of the present disclosure, and obviously, the described embodiments are merely a part of the embodiments of the present disclosure, and are not all embodiments. Based on the embodiments of the present disclosure, all other embodiments obtained by those skilled in the art without creative efforts shall fall within the scope of the present disclosure.

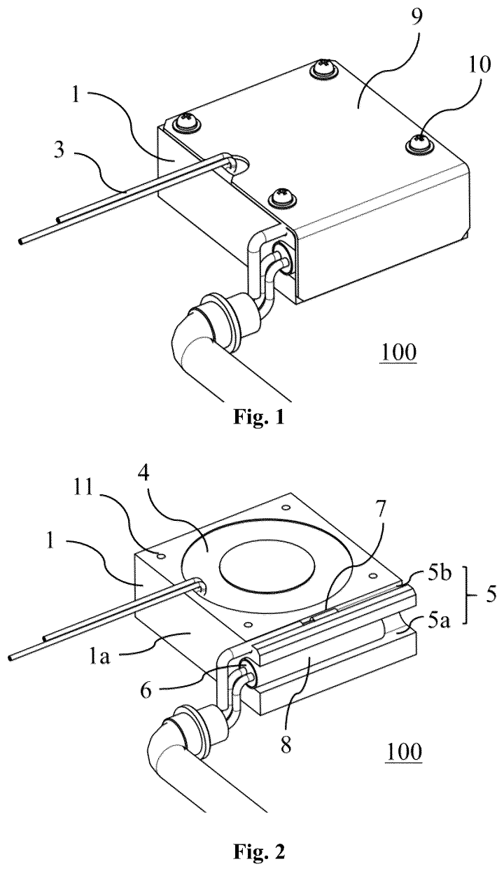

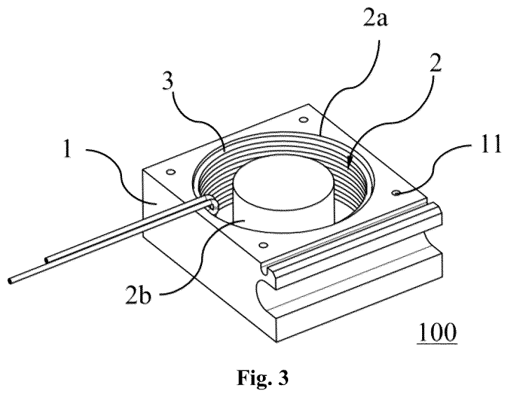

FIG. 1 is a schematic diagram of a structure of a heating module 100 according to the present embodiment. FIG. 2 is a schematic diagram of a structure of the heating module 100 obtained by removing a cover plate 9 of the heating module 100 according to the present embodiment. FIG. 3 is a schematic diagram of an assembly structure of a heating block 1 and a flash evaporation tube 3.

Referring to FIG. 3, in the present embodiment, the heating module 100 includes the heating block 1 and the flash evaporation tube 3. An annular groove 2 is opened in the center of the heating block 1. The annular groove 2 is a groove for housing the flash evaporation tube 3. Specifically, the flash evaporation tube 3 is wound in the annular groove 2.

Referring to FIG. 2, in the annular groove 2, a gap between the heating block 1 and the flash evaporation tube 3 is filled with solidified metal to form a metal filling portion 4. After the heating block 1 is heated, the heat is transferred to the flash evaporation tube 3 via the metal filling portion 4, and a liquid in the flash evaporation tube 3 is heated and vaporized.

In the present embodiment, a space between the flash evaporation tube 3 and the heating block 1 is densely filled with the metal filling portion 4, the heat transfer becomes more uniform and faster, and a temperature control becomes more precise.

In the present embodiment, a material of the metal filling portion 4 is selected from metals with a low melting point and a small volume change during a liquid-solid phase transition, and is preferably tin. When the metal is in a liquid state, the annular groove 2 in which the flash evaporation tube 3 is wound is filled with the metal, and the liquid metal can flow freely, so that the liquid metal can flow into the gap between the heating block 1 and the flash evaporation tube 3 to fill the gap. After that, as the temperature decreases, the liquid metal solidifies to become the metal filling portion 4 in the annular groove 2. According to the above method for producing the metal filling portion 4, the metal filling portion 4 obtained by solidification can still maintain a close contact with the flash evaporation tube 3 and the heating block 1 in the liquid metal state, so that the metal filling portion 4 can come into contact with the flash evaporation tube 3 and the heating block 1 with a larger area, heat transfer performance between the flash evaporation tube 3 and the heating block 1 is improved, stability of temperature transfer is especially improved.

In some embodiments, a metal with low melting point can be selected, and the heating block 1 can be heated to a temperature higher than the melting point of the metal to melt the metal. In order to ensure that the metal constituting the metal filling portion 4 does not flow out even if the metal melts during a heating process, an opening direction of the annular groove 2 is vertically upward. In this way, even if the metal of the metal filling portion 4 melts, the metal is carried in the annular groove 2 and does not leak out easily. Further, referring to FIG. 1, in the present embodiment, the heating module 100 also includes the cover plate 9 that covers a notch of the annular groove 2 and is fixedly connected to the heating block 1. The cover plate 9 fixedly connected to the heating block 1 can not only prevent an external insulation material of the heating module 100 from coming into contact with the metal filling portion 4, but also prevent the metal filling portion 4 in the annular groove 2 from overflowing even if vibration occurs after the metal filling portion 4 is heated and melts. In the present embodiment, the cover plate 9 is connected to the heating block 1 by threading. Specifically, four screw holes 11 having same diameter are evenly distributed on an outer periphery of the annular groove 2 in a circumferential direction, and the cover plate 9 is threadedly connected to the heating block 1 by using these four screw holes 11.

In the present embodiment, referring to FIG. 3, the annular groove 2 is specifically an annular shape, and includes an outer annular wall portion 2a and an inner annular wall portion 2b spaced apart from each other. The flash evaporation tube 3 is wound in the annular groove 2. Specifically, the flash evaporation tube 3 can be attached to the outer annular wall portion 2a for winding, that is, a radius of curvature of the winding is substantially equal to a radius of the outer annular wall portion 2a, so that a longer winding length and a larger contact area for heat transfer can be obtained, and deformation of the inert layer of the flash evaporation tube 3 can be reduced. Alternatively, the flash evaporation tube 3 can be attached to the inner annular wall portion 2b for winding, that is, the radius of curvature of the winding is substantially equal to a radius of the inner annular wall portion 2b. In addition, the flash evaporation tube 3 can also be wound around a bottom of the annular groove 2, or wound between the outer annular wall portion 2a and the inner annular wall portion 2b with a radius of curvature greater than the radius of the inner annular wall portion 2b and less than the radius of the outer annular wall portion 2a, which is not limited in the embodiments of the present disclosure.

Generally speaking, an inner wall of the flash evaporation tube 3 is coated with an inert layer (not shown), the inert layer is used to prevent the liquid in the flash evaporation tube 3 from corroding the inner wall of the flash evaporation tube 3 and to prevent the inner wall from adsorbing a sample. More preferably, in order to prevent the inert layer from being deformed and damaged during the winding process of the flash evaporation tube 3, in the present embodiment, the flash evaporation tube 3 is disposed in the annular groove 2 by winding and attaching to the outer annular wall portion 2a, this disposing manner can significantly increase the radius of curvature of the wound flash evaporation tube 3 and reduce a possibility of deformation and damage of the inert layer of the flash evaporation tube 3 due to excessive winding.

In addition, the outer annular wall portion 2a can provide a larger winding space for the flash evaporation tube 3, so that the flash evaporation tube 3 can be selected in more lengths according to actual use demands, and the outer annular wall portion 2a can provide a larger direct contact area for the flash evaporation tube 3, thereby improving a heat transfer effect between the outer annular wall portion 2a and the flash evaporation tube 3.

Continuing to refer to FIG. 2, the heating block 1 includes a metal block 1a, a heating rod housing groove 5a, a heating rod 6, a temperature sensor housing groove 5b, and a temperature sensor 7. The heating rod housing groove 5a and the temperature sensor housing groove 5b are both at an end on the same side of the heating block 1. The heating rod housing groove 5a and the temperature sensor housing groove 5b are both U-shaped grooves 5, and penetrate the heating block 1 along a length direction. An opening of the heating rod housing groove 5a is specifically disposed in a side surface of the heating block 1, and an opening of the temperature sensor housing groove 5b is specifically disposed in a top surface of the heating block 1. The heating rod 6 is disposed in the heating rod housing groove 5a, and the temperature sensor 7 is disposed in the temperature sensor housing groove 5b. In particular, the temperature sensor 7 is set in the center of the temperature sensor housing groove 5b along the length direction of the temperature sensor housing groove 5b to reduce a distance from the flash evaporation tube 3 and improve accuracy of temperature detection.

The heating rod 6 and the temperature sensor 7 are both cylindrical shapes, and bottoms of the U-shaped grooves 5 are arc shapes accordingly. The notch is a linear notch that may be closed at a certain degree, so that installation stability and convenience of the heating rod 6 and the temperature sensor 7 can be improved.

A metal foil 8 is wrapped on outer wall surfaces of the heating rod 6 and the temperature sensor 7, and the metal foil 8 is tightly attached to each of the heating rod 6 and the temperature sensor 7. A thickness of the metal foil 8 wrapped in different areas of the heating rod 6 is kept as consistent as possible. Outer diameters of cylindrical portions of the wrapped heating rod 6 and the wrapped temperature sensor 7 are substantially consistent with inner diameters of the heating rod housing groove 5a and the temperature sensor housing groove 5b, respectively, and since the metal foil 8 has ductility, the heating rod 6 and the temperature sensor 7 can be fixed in the heating rod housing groove 5a and the temperature sensor housing groove 5b in a tight fit manner. The metal foil 8 can maintain stable heat transfer between components in the presence of certain system tolerances or assembly tolerances. By opening the grooves to fix the heating rod 6 and the temperature sensor 7, the heating module 100 can be made more compact, the heat transfer becomes faster, and the temperature sensor can more accurately and sensitively reflect the real-time temperature of the flash evaporation tube 3.

In the present embodiment, the cover plate 9 not only covers the top of the annular groove 2, but also covers openings on sides of the U-shaped grooves 5. The cover plate 9 includes a top plate and a side plate that are integrally bent and formed. A size of the top plate is consistent with a size of the top surface of the heating block 1, and is disposed in a manner that edges overlap the top surface of the heating block 1. The top plate can completely cover the opening on the top of the annular groove 2 and the opening on the top of the temperature sensor housing groove 5b. A size of the side plate is consistent with a size of the side surface of the heating block 1, and is disposed in a manner that edges overlap the side of the heating block 1. The side plate can completely cover the opening on the side of the heating rod housing groove 5a. According to the above manner, the cover plate 9 can also limit positions of the heating rod 6 and the temperature sensor 7 to prevent the heating rod 6 and the temperature sensor 7 from escaping from the side of the heating block 1.

The heating module 100 according to the present embodiment can be applied to a flash evaporator. The flash evaporator may be connected to a gas chromatograph as a sample pretreatment device for the gas chromatograph to quickly evaporate a liquid sample into a gaseous sample and to measure contents of different components in the sample. The heating module 100 according to the present embodiment has better heat transfer performance, and can make different components in the sample evaporate quickly into gas within a substantially similar short period of time, thereby improving accuracy of component content detection.

The above embodiments are merely preferred embodiments of the present disclosure and are not intended to limit the present disclosure. Any modifications, equivalent substitutions, and improvements made within the spirit and principles of the present disclosure shall be included in the protection scope of the present disclosure.

What is claimed is:

1. A heating module comprising:
a heating block having a groove;
a flash evaporation tube disposed in the groove; and
a metal filling portion disposed in the groove to fill a gap between the heating block and the flash evaporation tube.

2. The heating module according to claim 1, wherein
the metal filling portion is formed by filling the groove with a liquid metal and solidifying the liquid metal.

3. The heating module according to claim 2, wherein
the liquid metal is tin, zinc, or aluminum.

4. The heating module according to claim 2, wherein
the groove is an annular groove, the annular groove includes an inner annular wall portion and an outer annular wall portion spaced apart from each other, and the flash evaporation tube is wound and attached to the outer annular wall portion.

5. The heating module according to claim 2, wherein
the groove extends in a vertical direction, and a notch of the groove is located at the top of the groove.

6. The heating module according to claim 5, further comprising:
a cover plate configured to cover the notch of the groove and fixedly connected to the heating block.

7. The heating module according to claim 1, wherein
the heating block includes:
a metal block;
a heating rod housing groove disposed at an end of the metal block; and
a heating rod embedded into the heating rod housing groove in a fitting manner.

8. The heating module according to claim 7, wherein
the heating block further includes:
a temperature sensor disposed at the end of the metal block.

9. The heating module according to claim 8, wherein
an outer wall of the heating rod and an outer wall of the temperature sensor are both wrapped with a metal foil.

10. A flash evaporator comprising:
the heating module according to any one of claim 1.
